(19) United States
(12) Patent Application Publication
(10) Pub. No.: US 2025/0032359 A1
(43) Pub. Date: Jan. 30, 2025

(54) TRANSFER APPARATUS HAVING AN OPENING COVER

(71) Applicant: SFM MEDICAL DEVICES GMBH, Wächtersbach (DE)

(72) Inventors: Christian URBACH, Künzell (DE); Corinna STICKER, Ronneburg (DE); Olaf BRÖMSEN, Mörfelden (DE)

(73) Assignee: SFM MEDICAL DEVICES GMBH, Wächtersbach (DE)

(21) Appl. No.: 18/696,580

(22) PCT Filed: Oct. 4, 2022
(86) PCT No.: PCT/EP2022/077526

§ 371 Date: Mar. 28, 2024

(30) Foreign Application Priority Data
Oct. 4, 2021 (DE) 10 2021 125 666.6

(51) Int. Cl. A61J 1/20

(52) U.S. Cl. CPC A61J 1/2089; A61J 1/2013; A61J 1/2075

(57) ABSTRACT

The invention relates to a transfer device for transferring of a medium, comprising a transfer unit (38) with a first lumen (54) carrying the medium and having a first opening (58) and with a second lumen (52) having a second opening (56) which has a shorter distance from the tip (60) of the transfer unit than the first opening, wherein a cover (64) intersected by a longitudinal axis (55) of the first lumen (54) having the first opening runs at a distance from the first opening (58). A retaining element (98) extends between the cover (64) and the first lumen (54) in order to keep material of a stopper of a container, pierced by the transfer unit (38), away from the first opening.

The invention relates to a transfer device for transferring, such as supplying or removing, a medium, such as a liquid, comprising a transfer unit with a first lumen carrying the medium and having a first opening, and with a second lumen having a second opening for pressure equalization which has a shorter distance from the tip of the transfer unit than the first opening, wherein a cover that extends from the transfer unit or is a section thereof and is intersected by the longitudinal axis of the first lumen having the first opening, runs at a distance from the first opening.

Transfer devices for pharmaceutical preparations, referred to as transfer sets in accordance with DIN EN ISO 22413 dated October 2013, are used to pass liquids from one container into another. Transfer sets mix liquids or dissolve dry substances and can be used in combination with infusion and injection containers.

While the term transfer device is used, it might also be replaced by the term transfer set.

Transfer sets are found for example in EP 1 329 210 B1 (unvented 2-part transfer set), EP 1 498 097 B1 (2-part transfer set vented on solvent side), WO 2018/111970 A2 (simple 1-part transfer set) or DE 1 822 605 U (vented 1-part transfer set).

Two-part transfer sets are frequently used for reconstitution of powdery medications contained in a medication vial with negative pressure. Examples of this are medications on a protein basis. Since these medications are very sensitive and with a tendency to denaturation, the water is removed from them by freeze-drying, also known as lyophilization, to preserve them longer. A negative pressure in the medication vial is created here as a result of the process. During reconstitution using an unvented 2-part transfer set, the liquid is drawn out of a solvent vial by means of the negative pressure in the medication vial. The solvent vial is here previously connected in a first step to a first adapter of the transfer set, in order to then fit the other adapter onto the medication vial after rotation by 180°. The liquid is drawn from the other vial due to the negative pressure in the medication vial. This continues until pressure equalization is achieved.

In some cases, however, the negative pressure in the medication vial is not high enough to completely extract the liquid from the other vial. For that reason, 2-part transfer sets vented on the solvent side are known, by which a connection is made to the surrounding air by means of a further lumen on the liquid side, so that no negative pressure arises on the solvent side during transfer, and instead ambient pressure always prevails. The result of this is that the entire liquid is extracted.

With such 2-part transfer sets having two lumens on the solvent side, there is however the risk of an air short circuit occurring between the openings of the lumens, leading to a full or partial pressure equalization between the vials, so that drawing of the liquid is either not possible or is incomplete. A usual solution for avoiding a short circuit is to position the upper openings of the two lumens at a considerable distance apart from one another along the axes. This however creates the draw back that the transfer set is constructed markedly longer and must also be made thicker and to give it stability, which in turn may lead to the disadvantage in actual practice that the closing stopper of the vial may be pushed into the vial when pierced and thus no transfer takes place.

In addition to 2-part transfer sets, 1-part transfer sets are known (e.g. so-called vial adapters, withdrawal spike). Simple 1-part transfer sets are used to supply the solvent to a vial with a liquid or powdery medication through a syringe filled with a solvent. During the subsequent removal of the reconstituted medication through a syringe, an increase in negative pressure arises inside the vial as more is removed, which in turn leads to an increasingly higher force, so-called aspiration force, at the control part of the syringe. Vented 1-part transfer sets prevent this increased aspiration force thanks to pressure equalization with the surrounding air.

A transfer device of the type stated at the outset is known from US 2015/0083950 A1.

EP 2 512 399 B1 relates to a transfer device with two lumens, wherein one lumen is intended for conveying liquid and the other lumen for venting.

The object underlying the present invention is to develop a transfer device of the type stated at the outset such that it is ensured that during a use where liquid is to be transferred, a pressure equalization takes place without an air short circuit occurring, but at the same time a compact design is made possible. This is intended to ensure that the flow of the liquid is not hindered.

A further aspect relates to the intended use of the transfer device for the careful transfer of liquid via the transfer device into a vial containing a medication. At the same time, the contact of the dissolved medication with the transfer device should be kept as low as possible.

To solve at least one of these aspects, the invention provides that a retaining element extends between the cover and the first lumen, in particular between the edge surrounding the first opening of the first lumen or the wall surrounding the first lumen or the bottom wall of the transfer device, and the first lumen, in order to keep material of a stopper of a container, pierced by the transfer unit, away from the first opening.

In line with the teachings in accordance with the invention, one of the openings is covered at a distance therefrom, such that there is no direct flow path between the openings: instead the cover has to be flowed around, thereby avoiding a short circuit.

The cover is roof-shaped.

A short circuit of this type could possibly be avoided even if the distance between the openings is relatively long. This is however not essential due to the teachings in accordance with the invention, so that a low design height results for the transfer unit in the axial direction of the transfer device, with the consequence that contact with the dissolved medication can be reduced in comparison with the prior art.

The possible short length of the transfer unit offers a further advantage. If the transfer device has a circumferential wall receiving a vial, the edge of the circumferential wall may thus extend above the tip of the transfer unit to an extent that the risk of injury for a user is ruled out or greatly reduced. According to the prior art, as may be found for example in EP 3 463 250 B1 or EP 2 512 399 B1, the tip of the transfer unit by contrast extends in the plane created by the edge of the circumferential wall.

The transfer device in accordance with the invention may be a 2-part transfer set vented on the solvent side, which ensures that in the case of a compact, short and thin design of the transfer unit, both pushing in of the vial stopper is prevented and an air short circuit is avoided. Ideally, the transfer unit should be configured so compact and short that it is inside a housing arranged cylindrically around the transfer unit and as a result is protected from being touched by the user, and thus cannot be contaminated thereby. Furthermore, centering of the transfer unit relative to the stopper is at the same time also achieved by a compact design of this type with an enclosing housing, so that the stopper is pierced centrally or approximately centrally at the place where it is thinnest and the risk of pushing in is minimized.

The transfer device in accordance with the invention may also be a vented 1-part transfer set, which ensures that while having a compact, short and thin design of the transfer unit, both pushing in of the vial stopper is prevented and contact of the dissolved medication with the transfer set is as low as possible, with the transfer unit not being dipped into the dissolved medication. Furthermore, a careful reconstitution of particularly sensitive freeze-dried proteins may be achieved by the transfer unit in that direct injection of the solvent onto the powder is avoided in such a way that the solvent jet is deflected laterally onto the wall of the vial. Due to this careful introduction, denaturation is reduced, and also the foaming which this frequently involves, and shortening of the reconstitution time is possible. This is of particular advantage for emergency medications in particular.

In particular, it is provided that the transfer unit is a cannula-like body with a tip and that distance A from the first opening to the tip differs from distance B from the further second opening of the further second lumen to the tip, in particular A>B, and preferably the second lumen with the second opening is connected at least in the case of the transfer device carrying the medium to the surrounding air, if necessary via a filter, or in the case of a dual-lumen dual-ended transfer device to the interior of a vial or interiors of vials.

The distance from the second opening to the bottom wall of the transfer device is thus greater than that from the first opening to the bottom wall.

Preferably, the cover extending at a distance from the first opening should be designed such that the cover has a first section with first side faces merging into the tip and a second section with second side faces extending therefrom, wherein each first side face forms an angle α to the longitudinal axis of the body and each second side face forms an angle β to the longitudinal axis, where α<β.

It may be provided here that the second section merges into a third section of the cover having two third side faces that form a reflex angle to the second side faces.

Preferably, the invention proposes that the first, second and third sections are limited on their sides remote from the second lumen by a front area, which is made up of a first front face area on the tip side merging into the first side faces and with first edges at a distance from the tip parallel or approximately parallel to one another, and/or an adjoining second front face area merging into the second side faces and having a first equilaterally trapezoidal geometry, and/or a third front face area merging into the third side faces and having a second equilaterally trapezoidal geometry, whose longer base coincides with the longer base of the second front face area or adjoins it.

A ledge-like section, limiting free spaces or passage openings for the medium to be transferred, here extends from the third section as a retaining element and preferably has a third equilaterally trapezoidal geometry, whose shorter base is preferably the shorter base of the third front face area or is a section thereof or merges into the latter.

The ledge provides in particular the advantage that when a stopper is pierced the material cannot penetrate into the space between the cover and the edge surrounding the first opening of the first lumen, whereby the opening may be at least partially closed. It is therefore provided in accordance with the invention that a spacer, such as a ledge, extends between the cover and the first lumen, in particular the edge surrounding the first opening of the first lumen or the wall surrounding the first lumen or the bottom wall, said spacer preventing any penetration from the stopper of a vial pierced by the transfer element into the space between the first opening and the cover or preventing it to an extent that closing of the first opening cannot occur.

Preferably, the ledge-like section should merge into a bottom-side partial ring section of the transfer unit or be a section thereof.

The possibility exists that a free edge of the partial ring section extending on the tip side is at a distance from the third section to form the free spaces, wherein in each case a free space is limited by a longitudinal lateral edge of the ledge-like section, by the partial ring section and by an inner longitudinal wall section of the transfer unit.

The longitudinal wall section should here merge into the transfer unit wall surrounding on the one hand the first lumen and on the other hand the second lumen at least in some areas.

Regardless of this, it is provided that the sections of the cover are designed very largely symmetrical to a plane in which the tip and the longitudinal axis of the first opening of the first lumen are located.

The first front face area may here have, starting from the tip, a convex outer surface extending symmetrically to the plane.

In particular, it is provided that the third side faces merge into one another.

The third side faces merging into one another act here as lateral deflectors for the medium when said medium is supplied via the transfer device.

It is ensured by this design for the third side faces that when liquid is passed via the transfer device into a vial containing a medication to be dissolved, the liquid is deflected via the third side faces laterally to the side wall of the vial and runs downward from there before almost vertically impacting onto the plane created by the medication, such that foaming is largely avoided. This permits careful reconstitution.

To ensure sufficient stability, ledges which project in radially extending manner above the bottom wall may extend on the bottom side from the cannula-like body, i.e. from the transfer unit.

In the bottom area of the transfer unit, and in particular limited by the bottom wall, extends at least one opening, preferably two openings, connected to the second lumen, in order to permit via the latter the supply of air, such as ambient air, to the vial to be emptied for pressure equalization.

The design of the transfer unit in accordance with the invention, where the first opening has a greater distance from the tip of the transfer unit than the second opening, with the cover and the retaining element is also applicable for a dual-lumen dual-ended transfer device. Both ends, or only one of the ends, of the dual-lumen dual-ended transfer device may have in this case a corresponding design in terms of the cover and retaining element.

Further details, advantages and features of the invention can be gathered not only from the claims and from the features to be found therein—singly and/or in combination—but also from the following description of preferred examples shown in the drawing.

The drawing shows in:

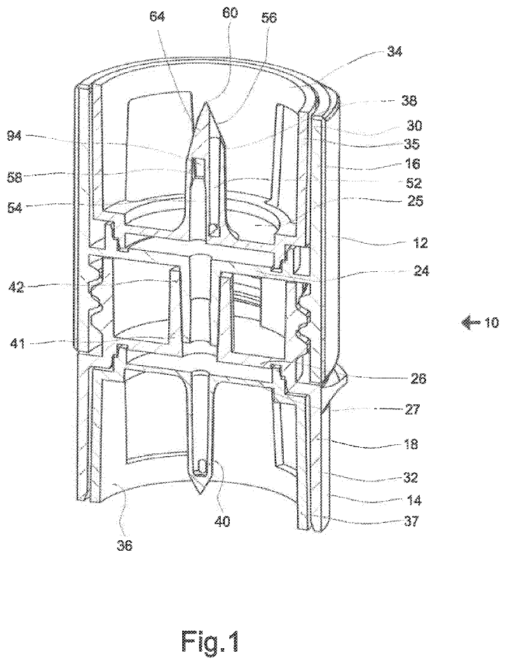

FIG. 1 a transfer device, partly in section,

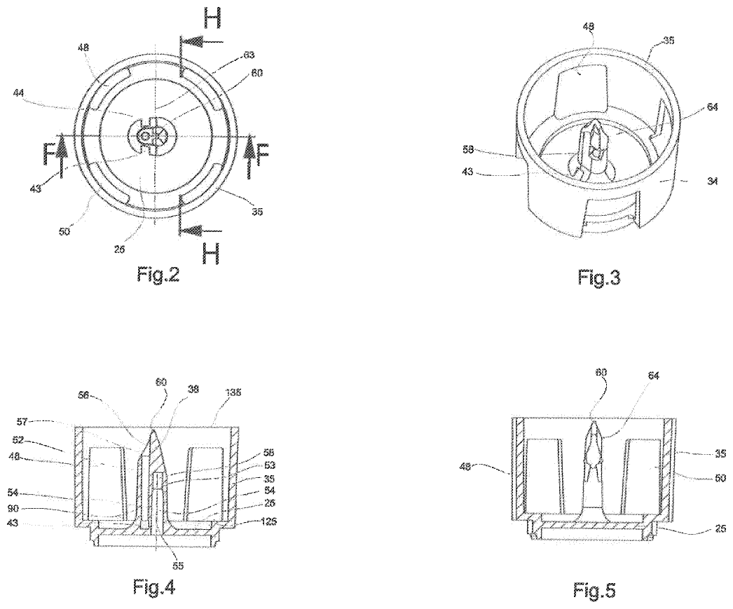

FIG. 2 an insert of the transfer device according to FIG. 1 in a plan view,

FIG. 3 the insert according to FIG. 2 in a perspective view and shown enlarged,

FIG. 4 a section along the line F-F in FIG. 2,

FIG. 5 a section along the line H-H in FIG. 2,

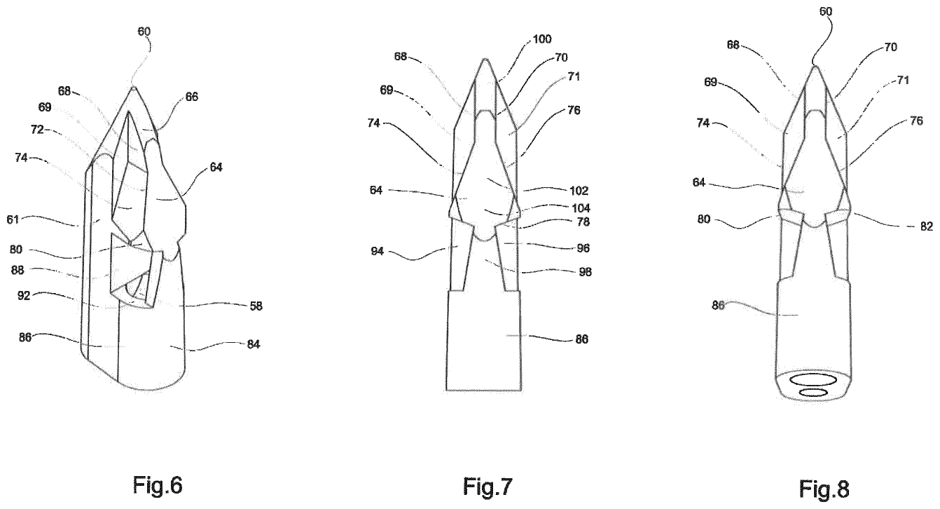

FIG. 6 a side view of a transfer unit, obliquely from above,

FIG. 7 the transfer unit in a front view,

FIG. 8 the transfer unit in the direction of the front side from underneath,

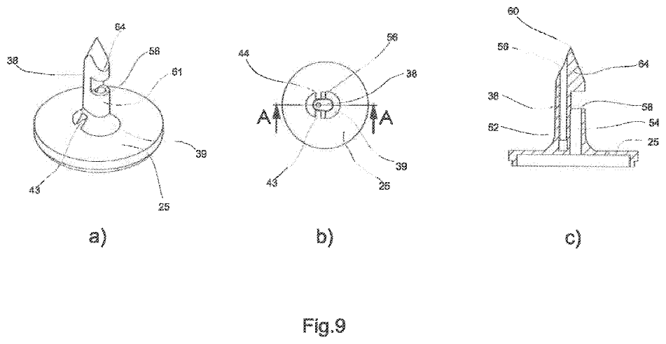

FIG. 9 schematic illustrations of a transfer unit in accordance with the invention,

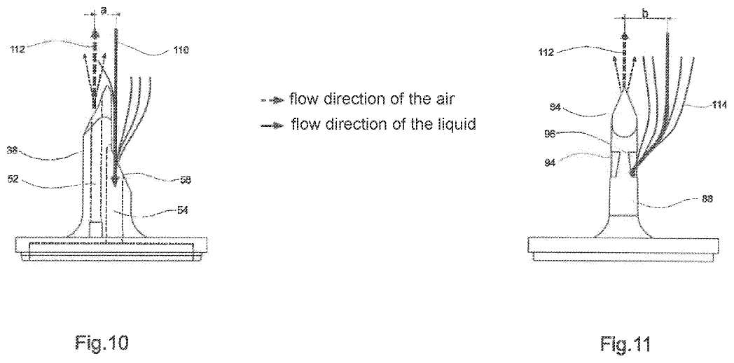

FIGS. 10 and 11 schematic illustrations of flow paths and

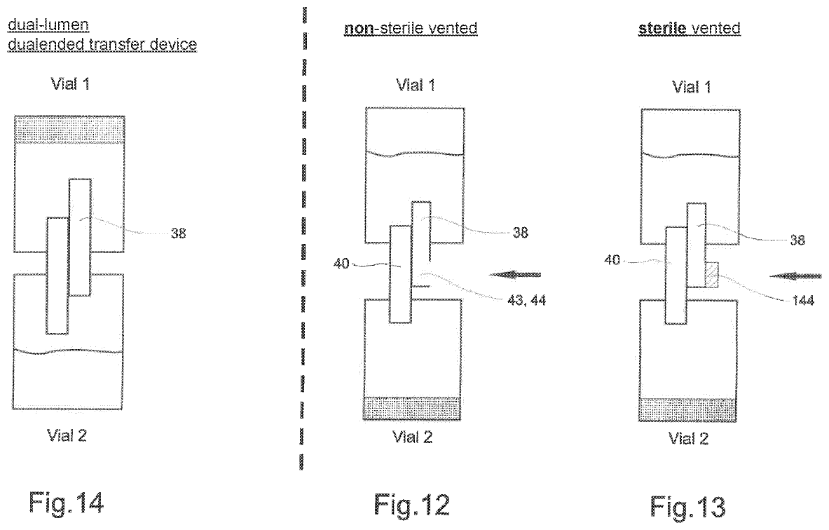

FIGS. 12-14 schematic illustrations of inserts of the transfer unit in accordance with the invention.

The teachings in accordance with the invention are explained on the basis of FIGS. 1-11, and relate to a dual-lumen arrangement of a transfer device or unit, referred to as a transfer set, by means of which reconstitution of medications is enabled by means of negative or positive pressure, in particular by means of negative pressure.

A transfer set 10 suitable for that purpose may be seen for example in FIG. 1, whose design corresponds to that of European Patent 3 240 520 B1, to the disclosure of which express reference is made. The disclosure of EP 3 240 520 B1 is an integral part of the present description.

The teachings in accordance with the invention are also suitable for any transfer set, also for example for that of EP 3 454 818 B1, according to which a liquid or medication solution is transferred from one container into another container, such as a vial or syringe body.

The teachings in accordance with the invention are however also intended for other transfer sets taken from the prior art and which can be found in the prior art stated at the outset. The dual-lumen arrangement known per se and in its own right is developed here such that when properly handled a short circuit between the lumens is ruled out, to ensure that a pressure equalization can be achieved to a sufficient extent, for either transferring a medium from one container into another container by means of negative pressure or for placing a medium into a container by pressure, since one of the lumens ensures the required pressure equalization to ensure proper transfer. At the same time, it is ensured that the opening of the lumen transferring the liquid may not be closed by material from a closure to be pierced, such as a stopper, of a container, such as a vial.

FIG. 1 shows purely in principle an example of a mixing or transfer set 10 in accordance with the invention.

The transfer set 10 has two adapters 12, 14 which are connected to one another by means of a screw connection. The adapters 12, 14 are used to receive containers, not shown, also referred to as vials, whose contents are to be mixed with one another. In particular it is provided here that one vial contains a medicinal substance, in particular in the form of a lyophilizate, and the other vial contains a liquid. The lyophilizate is subjected to negative pressure, so that when a connection is made between the vials, the liquid from of the one vial is drawn into the vial containing the lyophilizate, allowing reconstitution of the medication to be achieved.

In accordance with the illustration in FIG. 1, the adapter 12 serves to receive a vial containing a liquid, and the adapter 14 to receive the vial containing the medicinal substance.

The adapters 12, 14 each have a hollow-cylindrical outer body 16, 18, which may be referred to as a housing, which in the example are closed on the circumferential side and may consist of inherently stable plastic, so that stability in the shape is achieved.

While the respective outer body 16, 18 is designed as a hollow cylinder in the drawing representation, another shape is also possible, such as a polygonal-column geometry.

Each outer body 16, 18 has an intermediate wall 24, 26 extending vertically to the longitudinal axis of the adapter 12, 14. An insert 34, 36 with bottom wall 25, 27 and circumferential wall 35, 37 is placed into the space between the respective intermediate wall 24, 26 and the circumferential wall 30, 32 of the outer body 16, 18. A transfer unit 38, 40, which is also referred to as a cannula body or spike, extends from each bottom wall 25, 27 in the direction of the opening of the respective insert 34, 36, as is usually the case. The transfer unit 38 referred to in the following as a spike is here designed in line with the teachings in accordance with the invention, i.e. the spike 38 has two lumens, one of which is connected to the surrounding air, where necessary via a filter, to enable pressure equalization. By contrast, the other spike 40, which in accordance with previously stated explanations penetrates into a vial filled with a medication to be reconstituted, may have a single lumen, as may be seen in the drawing representation.

Facing away from the inserts, hollow-cylindrical bodies 41, 42, engaging in one another in sealing manner and designed in particular as Luer-Lock connections, extend from the intermediate walls 24, 26 when the adapters 12, 14 are screwed together.

Filters may be provided between the inserts 34, 36, i.e. their bottom walls 25, 27, and the intermediate walls 24, 26.

Furthermore, the inserts 34, 36 may have inward-pointing locking projections to engage behind the edge area of a vial and thereby ensure fixing inside the respective adapter 12, 14. Locking projections are not shown in the figures for reasons of clarity.

The circumferential wall 35, 37 of the insert 34, 36 is at a distance from the inner wall of the outer body 16, 18 at least in some sections.

The insert 34, 36 may furthermore consist of a more flexible material than the outer body 16, 18. In effect, decoupling is achieved by the distance between the outer body 16, 18 and the insert 34, 36.

During reconstitution of medications with negative pressure, firstly a vial with solvent is inserted into the upper adapter 12 in the drawing representation and fixed by means of the springy projections, in order to then rotate the transfer device 10 by 180° and fit the adapter 14 onto the medication vial subjected to negative pressure.

Since approximately ambient pressure prevails in the solvent vial, liquid is drawn, after a connection has been made between the vials, due to the negative pressure prevailing in the medication vial.

If the spike 38 were to have only one lumen, a transfer, i.e. drawing, of liquid would then be prevented if the pressure in the vials were to be equal. If the negative pressure in the medication vial is not sufficiently high, pressure equalization is reached before the liquid transfer is completed. To prevent this, one lumen is connected to the surrounding air so that liquid may be transferred to a sufficient extent, since a negative pressure cannot build up in the liquid vial during extraction.

The spike 38 extending from the bottom wall 25 of the insert 34 has a lumen 52, referred to as the second lumen, which is connected to the surrounding air, and a lumen 54, referred to as the first lumen, via which liquid, such as solvent, flows when the spike 38 pierces the stopper of a vial fitted onto the insert 34 and the spike 40 passes through the stopper of the medication vial in which a negative pressure prevails. To do so, the vials are fixed into the inserts 38, 40 by means of projections.

As is discernible from the drawing representation, the opening 56, referred to as the second opening, of the second lumen 52 permitting pressure equalization is at a greater distance from the bottom wall 25 than the opening 58, referred to as the first opening, of the first lumen 54.

The tip 60 of the spike 38, by means of which the stopper of the vial is pierced, is at a distance from the opening 56 of the second lumen 52. The specific form of the spike 38 permits puncturing thanks to a practically point-like application of force, but at the same time ensures to a sufficient extent, due to the cross-sectional widening of the spike 38, that the stopper to be pierced is further torn open during the further process of penetration by the spike, wherein ease of movement is achieved by the course of the outer face of the spike 38. It is in particular provided here in accordance with the invention that the stopper is, in the area of the opening 58 of the first lumen 54, torn open to an extent that the liquid may be drawn through the stopper and into the medication vial, avoiding or largely avoiding any flow resistance. At the same time, it is ensured that the first opening 58 cannot be closed by the stopper or by material of the stopper or closed in such a way that a liquid transfer is prevented, as is explained in the following.

It is further ensured by the teachings in accordance with the invention that a short circuit between the openings 56, 58 of the lumens 52, 54 is prevented, i.e. that air may not be sucked directly into the first lumen 54.

These advantages are achieved in that the opening 58 of the first lumen 54 in the spike 38 is located such that a cover 64 which is a section of the body of the spike 38 is provided above it. The cover 64 has here an outer geometry comprising sections that extend to the tip 60 of the spike 38, to permit point-like opening of a closing stopper of a vial and tearing it open to permit the previously described advantages to be achieved. The cover 64 is intersected by the longitudinal axis 55 of the first lumen 54 and extends approximately parallel to the bottom wall 25 of the insert 34, such that the projection of the first opening 58 extends in the longitudinal axis direction inside the cover 64.

The design of the spike 38 is explained purely in principle on the basis of FIG. 9. The other Figs. explain noteworthy embodiments.

FIG. 9 shows purely in principle the bottom wall 25 of the insert 34 with the spike 38 extending from said bottom wall 25.

The spike 38 has a bottom section 39 extending from the bottom wall 25 and tapering in the direction of the body 61 of said spike 38. Ducts 43, 44 connecting the second lumen 52 to the surrounding air are provided in the bottom section 39.

As is shown in the perspective view according to FIG. 9a, a cover 64 with in particular roof-like geometry extends at a distance from the first opening 58, i.e. from the opening of the first lumen 54, via which a connection is made to the spike 40 by the inter-engaging Luer-Lock connection elements 41, 42, via which cover it is ensured that air entering via the second lumen 52 cannot flow directly into the first opening 58, i.e. there is no short circuit and instead the air is deflected such that the liquid present in the vial received by the first adapter 12 may be extracted to the required extent via the first lumen 54.

FIG. 9b shows a plan view onto the bottom wall 25 with the spike 38. The bottom section 39 extending from the bottom wall 25 may be discerned, with the duct-like openings 43, 44 that are connected to the second lumen 52.

FIG. 9c shows a section A-A by which the bottom wall 25 with the spike 38, the first lumen 54 and the second lumen 52 with the openings 58, 56 and the cover 64 are once again clearly discernible. Also, the illustration makes clear that the second opening 56 has a shorter distance from the tip 60 of the spike 38 than the first opening 58 of the first lumen 54.

Preferably, the ratio of the distance of the first opening 58 of the first lumen 54 from the tip 60 is 3:1 to 2:1, in particular 2.4:1, to that of the second opening 56 from the tip 60, i.e. the distance of the first opening 58 from the tip 60 is for example two to three times greater than that of the second opening 56 from the tip 60. The edge area of the corresponding opening 56, 58 furthest from the tip 60 is taken into account here. In FIG. 4, this would be the area 57 of the second opening 56 and the area 53 of the first opening 58.

FIGS. 6 to 8 are intended to explain the preferred design of the spike 38 with the cover 64, which ensures that an unwanted short circuit is basically ruled out when air is drawn into a vial containing a liquid, the stopper of which is passed through by the spike 38.

The spike 38 has, in the section covering the first lumen 54 or its opening 58, a first area or section 66, merging into the tip 60, with first side faces 68, 70, said section merging into a second section 72 with second side faces 74, 76, wherein each first side face 68, 70 of the first section 66 forms an angle α to the longitudinal axis of the spike 38, i.e. its body, and each second side face 74, 76 of the second section 72 forms an angle β to the longitudinal axis, where a is smaller than B. In particular, the first side faces 68, 70 extend practically parallel to one another and parallel to the longitudinal axis of the spike 38.

The second section 72 merges into a third section 78 having side faces 80, 82 which face the opening 58 of the first lumen 54 and have practically a convex-like geometry relative thereto, i.e. a curvature which may in turn consist of sections, as may be discerned in principle from the drawing. These sections form a V-like geometry when viewed in the direction of the side faces 74, 76 in section.

This part of the spike 38, consisting of the first, second and third areas 66, 72 and 78, is referred to overall as the cover 64 for the first opening 58, even if the third side faces 80, 82 strictly speaking cover the first opening 58 at a distance. The areas or sections 66, 72, 78 are formed in that part of the spike body 61 in which the first lumen 54 extends.

The first lumen 54 is surrounded in some sections on the circumferential side by a partial ring-like wall 86 of the spike body 61 with outer face 84. This is adjoined by a limiting face 88 of the spike body extending parallel to the longitudinal axis of the spike 38, which limits the section 90 of the spike body 61 in which the second lumen 52 with the opening 56 extends.

The partial ring section 86 extends with its edge 92 extending on the tip side at a distance from the third side faces 80, 82, thereby forming two openings 94, 96 which are separated by a ledge 98 which extends from the partial ring section 86 and as far as the third section 78, as is made clear in particular in FIG. 7. This ledge 98 has in the plan view a trapezoidal geometry, whose shorter base merges into the third section 78 or is a section thereof.

The ledge 98 results in a noteworthy inventive property of the transfer device.

In a compact design of the transfer unit, i.e. of the spike 38, the first opening 58 of the first lumen 54 may be located close to the area of the bottom 25. If a stopper, such as a rubber stopper, is pierced by the spike 38, there may be a risk, if the ledge 98 is absent, of stopper material penetrating into the space between the cover 64 and the first opening 58 to an extent that the latter is at least partially closed. The ledge 98 ensures that the stopper material is kept clear of the first opening 58, so that liquid can be drawn to the required extent via the passage openings 94, 96 and the first opening 58.

As may be seen in particular from FIGS. 6 to 8, the first side faces 68, 70 merge into a first front face area 100, rectangular in some areas, that leads to the tip 60 of the spike 38: the second side faces 74, 76 merge into an adjoining second front face area 102 having an equilaterally trapezoidal geometry; and the third side faces 80, 82 merge into a third front face area 104 having an equilaterally trapezoidal geometry, wherein the longer base of the second front face area 102 and the longer base of the third front face area 104 coincide or merge into one another.

To avoid an air short circuit between the openings 56, 58 and to equalize the respective capillary forces, the air outlet opening 56 is arranged close to the tip 60 of the spike 38. At the same time, the angle of the tip 60 is limited by this.

Thanks to the geometry of the spike body 61 above the first opening 58 of the first lumen 54, it is firstly achieved that an almost point-like load is applied during piercing of a stopper of a vial, so that the forces to be applied are low. This is achieved in particular by the first area or section 66 extending from the tip 60 with its side faces 68, 70 parallel to one another or almost parallel to one another, and by the outwardly convex front area 60. The first area or section 66 is limited here by a surface extending parallel to the longitudinal axis of the spike 38 and divided by the first section 66, whose sections 69, 71 extend in a common plane which is parallel to the longitudinal axis of the spike 38, wherein the plane preferably intersects the tip 60. The surface sections 69, 71 limit a section of the spike 38 which faces away from the first lumen 54 and extends around the second lumen 52.

In its further course, the tip area is, due to the second side faces 74, 76, enlarged to the maximum width at the transition between the second and third side faces 74, 76 and 80, 82 respectively, such that the stopper may be torn open to the required extent.

The spike body 61 then has an almost constant cross-section in the area of the ledge 98 and of the ring section 86, such that safe sliding of the stopper on the spike body 61 is possible. The stopper may therefore be in contact with the area of the ring section 86 to a sufficient extent, such that the openings 94, 96 are uncovered for passage of the solvent, thus assuring extraction via the first lumen 54.

Since the cover 64 in the third section 78 is greater than that of the first opening 58, a further advantage achieved is that the punching out of rubber particles of the closing stopper by the edge of the first lumen 54 is prevented.

Since the first and second side faces 68, 70, 74, 76 recede from the outer edges of the sections 69, 71 that determine the width of the spike 38, the load applied to pierce a closing stopper is reduced in comparison to spikes which do not have corresponding cross-sectional reductions in the tip area.

The ledge 98 extending between the openings 94, 96 and merging into the third section 78 ensures that the closing stopper enclosing the spike 38 cannot close the second opening 58. Due to the tapering of the ledge 98 from the ring section 86 to the cover, the openings 94, 96 are sufficiently large to allow liquid to flow to the first lumen 54.

This is in particular also enhanced in that the tip 60 of the spike 38 is off-center in the insert 35, i.e. at a distance from its longitudinal axis 63, as shown in principle in FIG. 2.

The height of the liquid entry opening 58 results from the requirements for a minimum residual volume for various vials and closing elements, and for an optimum distance from the opening 56 enabling the pressure equalization, so that a sufficiently large pressure difference results. This allows the greater capillary forces of the lumen 52 carrying the air to be reduced in comparison to the lumen 54 carrying the liquid, thereby preventing any liquid from entering the second lumen 52, or reducing it to an acceptable extent.

The risk of an air bypass, i.e. short circuit, is minimized by the course of the second and third side faces 74, 76, 80, 82 and the maximum width extent of the spike body 61 through the third section 78 above the first opening 58.

In other words, the projection of the first opening 58 in the longitudinal direction of the first lumen 54 is smaller than the surface of the third side faces 80, 82 extending above the first opening 58 and facing said opening 58. The first opening 58 in a corresponding projection is completely inside the third side faces 80, 82.

Since the third side faces 80, 82 that merge into one another, i.e. form a closed surface, show a convex-like course in relation to the first opening 58, this also results in the advantage that when a transfer device with the spike 38 designed in accordance with the invention is used to introduce liquid into a container by positive pressure, i.e. when the tip 60 is underneath a liquid exit opening corresponding to the opening 58, the liquid exiting from the opening 58 impacts on the obliquely extending side faces 80, 82, and thus a lateral deflection of the liquid jet onto the inner faces of the vial is achieved, such that the medication present in the vial may be dissolved with less turbulence, and hence with more care.

If a dissolved medication is extracted from a vial by means of a transfer device with the spike 38 designed in accordance with the invention, a withdrawal is possible using considerably lower forces in comparison with the prior art due to the spike design in accordance with the invention.

FIGS. 2 to 5 again show various views of or sections through the insert 35 that are self-explanatory, to make the design of the spike 38 in accordance with the invention clearly discernible. The sectional views F-F and H-H also show in particular that the tip 60 of the spike 38 is set back from a plane 135, i.e. in the direction of the bottom wall 25, that is created by the upper edge of the circumferential wall 35 of the insert 34. The tip 60 thus does not project above the insert 34, minimizing the risk of injury for a user. The risk of contamination is also reduced.

In particular, the perspective view of FIG. 3 shows once again the characteristic features of the cover 64, which extends at a distance from and above the first opening 58 of the first lumen 54.

Furthermore, it may be seen that cutouts are provided in the circumferential wall 35, two of which are identified with the reference numbers 48, 50. The projections, not shown, protruding into the interior of the insert 34 extend in the area of the cutouts 48, 50 in order to engage behind the edge of a vial and fix it in place.

Furthermore, it is discernible that the intermediate wall 25 merges into the circumferential wall 35 via an all-round step 125 or ledge. The front edge of a vial rests on the step 125 or ledge, such that the duct-like openings 43, 44 making the connection of the ambient air to the second lumen 52 remain uncovered. This can be seen as an independently inventive feature. The number of connections to the second lumen 52 may of course also be higher or lower than two.

It is achieved by the off-center course of the tip 60 that the circumferential surface of the spike 38 extending adjacent to the liquid passage openings 94, 96 may be closer to the longitudinal axis 63 of the adapter 12 in comparison to an arrangement in which the tip is arranged centered, i.e. passed through by the longitudinal axis 63. Hence more space or cross-sectional area is available in the area of the passage openings 94, 96 for the stopper material which is to be pierced, so that the stopper material may slide along the circumferential surface of the spike 38 without the openings 94, 96 being closed.

The roof-like cover 64 forms a flow resistance for the liquid flowing in the direction of the bottom wall 25 which, due to the roof-like design widened in the direction of the bottom wall 25, i.e. the cross-sectional enlargement from the tip 60 in the direction of the bottom wall 25 effected by the cover 64 and showing a non-symmetrical conical course, is deflected and does not flow practically parallel to the longitudinal axis 55 of the first lumen 54. The liquid is that which is present in a vial, the stopper of which is pierced by the spike 38.

The influencing of the flow behavior is explained purely in principle based on FIGS. 10 and 11. In FIG. 10, the main flow line of the liquid is identified with the reference number 110, wherein a cover is not provided for the first opening 58 of the first lumen 54.

The main flow line of the air flowing into the vial is identified with the reference number 112, said air being supplied via the second lumen 52. The distance between the main flow lines 110, 112 is identified with a.

If a cover 64 in accordance with the invention is located at a distance from the first opening 58 of the first lumen 54, and if the liquid enters via the openings 94, 96 into the space between the cover 64 and the first opening 58, in order to be drawn by means of a negative pressure present in a second vial, the main flow line of the drawn liquid 114 extends further away from the spike 38, so that the distance between the main flow line 112 of the drawn air and the main flow line 114 of the liquid is b, wherein b>a, as is self-explanatory from FIGS. 10 and 11. The faster the liquid flows or is transferred, the more pronounced the deflection of the drawn liquid and thus the greater the distance b. There is no corresponding influencing for the drawn air. This is relevant because the shorter the distance a or b is, the more likely the air exiting from the second opening is carried along against its actual upward direction. It is thus achieved, due to the roof-like geometry of the cover 64, that a short circuit between the second opening 56 of the second lumen 52 and the first opening 58 of the first lumen 54 is prevented or reduced in its scale, such that the liquid in the vial in which the spike 38 extends may be extracted to a sufficient extent.

The distance between the first opening 58 and the cover 64, i.e. the surface passed through by the longitudinal axis 55 of the first lumen, which is at the intersection point of the side faces 80, 82 of the third section 78, is preferably 2 mm to 3 mm, in particular 2.5 mm or approximately 2.5 mm. Starting from the intersection point, the distance of the side faces 80, 82 relative to the first opening 58 increases, as has been previously explained.

FIGS. 12-14 are intended to explain, purely in principle, typical applications of the transfer unit in accordance with the invention, wherein FIGS. 12 and 13 correspond in their design principle and application to the previously described embodiment, in which the container is referred to as vial 2 in FIG. 12 contains a medicinal substance, wherein the vial 2 is connected to the liquid-containing vial 1 via the transfer unit 38 in accordance with the invention and via the transfer unit 40, preferably of the previously explained design, in order to then draw the liquid present in the vial 1, due to the negative pressure prevailing in the vial 2, via the transfer units 40, 38. The transfer unit 38 is, according to FIG. 12, connected to the ambient air via at least one opening 43, 44, as has been previously explained.

FIG. 13 differs from FIG. 12 solely in that the ambient air flowing via the transfer unit 38 into the vial 1 previously passes through a filter 144, so that sterile venting is achieved.

FIG. 14 indicates that the vials 1 and 2 are connected to one another via a dual-lumen dual-ended transfer device. The transfer unit has two lumens. A handle extends in the central area of the transfer unit so that the tips of the transfer device can pierce the closing stoppers of the vials 1 and 2. The handle may form at the same time a penetration limiter.

At least one end area of the dual-ended transfer device is designed corresponding to the transfer unit 38, i.e. a cover is associated with the opening having a greater distance from the tip of the transfer unit—corresponding to the first opening 58. There is also a retaining element ensuring that the pierced closing stopper cannot close the opening closer to the handle, i.e. the first opening 58 in accordance with FIGS. 1-11.

The opposite end of the transfer unit likewise has two openings. Liquid is extracted from the vial 2 due to the negative pressure prevailing in the vial 1 via the lumen, whose opening in the vial 2 has a greater distance from the tip of the double-end cannula extending in the vial 2 than the opening of the second lumen.

As is usual with dual-lumen dual-ended transfer devices, the openings of the lumens are at a distance from one another at the respective ends of the transfer unit.

At one end of the dual-ended transfer device, the opening of the first lumen is at a greater distance from the tip than the opening of the second lumen, whose opening at the other end of the dual-ended transfer device has a shorter distance from the tip of the other end than the opening of the first lumen.

1-19. (canceled)

20. A transfer device (10) for transferring, such as supplying or removing, a medium, such as a liquid, into or out of a container connected to the transfer device, comprising a transfer unit (38) extending from a bottom wall (25) or handle or penetration limiter, with a first lumen (54) carrying the medium and having a first opening (58), and with a second lumen (52) having a second opening (56), wherein the second opening has a shorter distance from a tip (60) of the transfer unit than the first opening, wherein a cover (64) that extends from the transfer unit (38) or is a section thereof and is intersected by a longitudinal axis (55) of the first lumen (54) having the first opening runs at a distance from the first opening (58),
wherein the second lumen (52) permits an air pressure equalization in the container and that a retaining element (98) extends between the cover (64) and an edge (92) surrounding the first opening (58) or the first lumen (54) in order to keep material of a stopper of a container, pierced by the transfer unit (38), away from the first opening.

21. The transfer device according to claim 20, wherein the cover (64) has a first section (66) with first side faces (68, 70) merging into the tip (60) of the transfer unit (38) and a second section (72) with second side faces (74, 76) extending therefrom, wherein each first side face forms an angle α to the longitudinal axis direction of the transfer unit (38) and each second side face forms an angle β to the longitudinal axis, where α<β.

22. The transfer device according to claim 21, wherein the second section (72) merges into a third section (78) of the cover (64) having two third side faces (80, 82) that form a reflex angle to the second side faces (74, 76).

23. The transfer device according to claim 22, wherein the first, second and third sections (66, 72, 78) are limited on their sides remote from the second lumen (52) by a first front area (100), which is made up of a first front face area on the tip side merging into the first side faces (68, 70) and with first edges at a distance from the tip (60) parallel or approximately parallel to one another, and/or an adjoining second front face area (102) merging into the second side faces (74, 76) and having a first equilaterally trapezoidal geometry, and/or a third front face area (104) merging into the third side faces (80, 82) and having a second equilaterally trapezoidal geometry, whose longer base coincides with the longer base of the second front face area or adjoins it.

24. The transfer device according to claim 22, wherein a ledge-like section, limiting free spaces or passage openings (94, 96) for the medium to be transferred, extends from the third section (78) as the retaining element (98) which has a third equilaterally trapezoidal geometry, whose shorter base is the shorter base of the third front face area or is a section thereof or merges into the latter.

25. The transfer device according to claim 24, wherein the ledge-like section merges into a bottom-side partial ring section (86) of the transfer unit (38) or is a section thereof.

26. The transfer device according to claim 24, wherein a free edge of the partial ring section (86) extending on the tip side is at a distance from the third section (78) to form the free spaces (94, 96), wherein in each case a free space is limited by a longitudinal lateral edge of the ledge-like section, by the partial ring section and by an inner longitudinal wall section of the transfer unit (38).

27. The transfer device according to claim 26, wherein the longitudinal wall section merges into a transfer unit wall surrounding on the one hand the first lumen (54) and on the other hand the second lumen (52) at least in some areas.

28. The transfer device according to claim 20, wherein the sections of the cover (64) are designed symmetrical to a plane in which the tip (60) and the longitudinal axis (55) of the first lumen are located.

29. The transfer device according to claim 23, wherein the first front face area (100) has, starting from the tip (60), a convex outer surface extending symmetrically to the plane.

30. The transfer device according to claim 20, wherein the transfer unit (38) extends from a bottom wall (25), in particular from an insert (34), of the transfer device (10), that the bottom wall merges via a step or ledge (125) into a circumferential wall (35) receiving a container that rests on said step or ledge on the opening side, and that the transfer unit has in the area of the bottom wall at least one opening (43) via which air is drawable into the second lumen (52) from the area of the bottom wall.

31. The transfer device according to claim 22, wherein the third side faces (80, 82) merge into one another.

32. The transfer device according to claim 22, wherein the third side faces (80, 82) merging into one another act as lateral deflectors for the medium when said medium is supplied via the 1-piece transfer device.

33. The transfer device according to claim 20, wherein the cover (64) has a surface at a distance from the first opening (58) and intersected by the longitudinal axis (55) of the first lumen (54), said surface having a convex course relative to a plane (80, 82) extending vertically to the longitudinal axis.

34. The transfer device according to claim 20 wherein the projection of the first opening (58) of the first lumen (54) in its longitudinal axis direction extends inside the cover 64.

35. The transfer device according to claim 20, wherein a body (61) of the transfer unit (38) has on the bottom side a cross-section having an oval geometry and/or a tip (60) of the transfer unit is off-center relative to a circumferential wall (35) surrounding the transfer unit (38).

36. The transfer device according to claim 20, wherein a length of the transfer unit (38) is less than a height of a circumferential wall (34) of the transfer device (10) surrounding the transfer unit.

37. The transfer device according to claim 20, wherein the transfer unit is at least an end area of a dual-lumen dual-ended transfer device.
